(19) United States
(12) Patent Application Publication
(10) Pub. No.: US 2019/0035103 A1
(43) Pub. Date: Jan. 31, 2019

(54) HIGH ACCURACY CAMERA POSITION DATA METHOD AND MIXTURE FOR AUTOMOTIVE CRASH TEST ANALYSIS

(71) Applicant: Jesus Rodrigo Cedeno Jimenez, Mexico City (MX)

(72) Inventor: Jesus Rodrigo Cedeno Jimenez, Mexico City (MX)

(21) Appl. No.: 15/658,593

(22) Filed: Jul. 25, 2017

(51) Int. Cl. G06T 7/70; H04N 5/247; G06T 7/292; G01M 17/007

(52) U.S. Cl. CPC G06T 7/70; G01M 17/0078; G06T 7/292; H04N 5/247

(57) ABSTRACT

At least 20 left side and 20 right side visual targets are supported on a movable fixture at different points in a 3D space, and with at least 5 of each 20 visual targets positioned at different Y-dimension distances. Locations of the right side and left side visual targets are measured or determined relative to each other. The movable fixture is positioned in a static position adjacent an automotive crash test barrier with the targets being spaced throughout only a portion of the field of view of each of the fixed digital cameras. Each of a plurality of fixed digital camera takes a single photograph of the movable fixture in the static position to obtain the photographic data or information. The movable fixture is moved away from the automotive crash barrier prior to performing an automotive crash test using the barrier.

### FIELD

The present disclosure relates to obtaining photographic data or information sufficient to determine a position, including orientation, of each of a plurality of fixed digital cameras with respect to a point in 3D space with the accuracy required for automotive crash testing stereoscopic 3D motion analysis.

### BACKGROUND

Automotive crash test stereoscopic 3D motion analysis uses a plurality of fixed cameras. The cameras remain in a fixed position because the motion that is being captured occurs so fast that camera movement is impractical. Because the cameras are fixed, each camera must have a relatively large field of view in order to adequately capture all desired movement.

In addition, automotive crash test stereoscopic 3D motion analysis requires a high degree of accuracy. For example, in most instances automotive crash test stereoscopic 3D motion analysis requires that any Parallax error be no more than about 2.5 mm. In some cases, automotive crash test stereoscopic 3D motion analysis requires that any Parallax error be no more than about 1 mm. Obtaining such a high degree of accuracy was thought to require positioning visual targets in the space throughout all or substantially all of the field of view of the fixed cameras. For example, attempts to use the visual targets fixed to the vehicle being tested for camera coordinate determination purposes have been unable to achieve such a high degree of accuracy.

The combined requirements for a high degree of accuracy and multiple fixed cameras with large fields of view have meant that a large number of targets must be positioned throughout a large space. Then the relative positions of this relatively large number of widely spaced targets must be measured with a high degree of accuracy. Typically, measuring the positions of such targets with the high accuracy required for automotive crash test 3D analysis requires engaging an outside contractor with the required special equipment and expertise, and requires shutting down the crash test facility for a day or more to accommodate the contractor and equipment. In other words, this is an extremely time consuming and costly process.

### SUMMARY

In an aspect, a high accuracy method of obtaining photographic data or information sufficient to determine a position, including orientation, of each of a plurality of fixed digital cameras with respect to a point in 3D space with an accuracy required for automotive crash testing stereoscopic 3D motion analysis is provided. At least 20 left side visual targets are supported on a movable fixture at different points in a 3D space of the movable fixture, and with at least 5 of the 20 left side visual targets positioned at different Y-dimension distances. At least 20 right side visual targets are supported on the movable fixture at different points in the 3D space of the movable fixture, and with at least 5 of the 20 right side visual targets positioned at different Y-dimension distances. Locations of the right side and left side visual targets are measured or determined relative to each other on the movable fixture. The movable fixture, which rigidly supports the plurality of visual targets relative to each other, is positioned in a static position adjacent an automotive crash test barrier with the plurality of targets being spaced throughout only a portion of the field of view of each of the fixed digital cameras. Each fixed digital camera takes a single photograph of the movable fixture in the static position to obtain the photographic data or information. The movable fixture is moved away from the automotive crash barrier prior to performing an automotive crash test using the barrier.

In an aspect, at least 20 upper side visual targets are supported on the movable fixture at different points in a 3D space of the movable fixture and with at least 5 of the 20 upper side visual targets positioned at different Z-dimension distances. At least 20 lower side visual targets are supported on the movable fixture at different points in the 3D space of the movable fixture and with at least 5 of the 20 lower side visual targets positioned at different Z-dimension distances. Locations of the upper side and lower side visual targets are measured relative to each other and relative to the left and right visual targets on the movable fixture.

In an aspect, the movable fixture is positioned in a different static position adjacent a different automotive crash barrier with the plurality of targets being spaced throughout only a portion of the field of view of each of the fixed digital cameras or a different plurality of fixed digital cameras. Each fixed or different fixed digital camera takes a single photograph of the movable fixture in the different static position to obtain the photographic data or information. The fixture is moved away from the different automotive crash barrier prior to performing an automotive crash test using the different barrier.

In another aspect, the portion of the field of view is less than about 80 percent of the field of view of each of the fixed or different digital cameras.

In another aspect, the plurality of visual targets are supported within the 3D space that has overall X, Y and Z dimensions that are less than about corresponding overall X, Y and Z dimensions of an automobile to be tested.

In another aspect, the plurality of visual targets are supported within the 3D space that has an overall X dimension that is less than about 1.5 meters, an overall Y dimension that is less than about 2 meters, and an overall Z dimension that is less than about 5 meters.

In another aspect, a zigzag base of the movable fixture is positioned adjacent the crash test barrier with a plurality of arms of different heights extending upward from the zigzag base of the movable fixture and with the visual targets supported on the arms, the zigzag base, or both.

In another aspect, positioning the movable fixture includes positioning a foot of the movable fixture in a winch rail opening adjacent the crash test barrier.

In another aspect, a mechanical arm-type coordinate measuring device is used to measure locations of all the visual targets.

In an aspect, the photographic data or information obtained from the single photograph from each camera is sufficient to determine a position, including orientation, of each of a plurality of fixed digital cameras with respect to a point in 3D space with an accuracy required for automotive crash testing stereoscopic 3D motion as noted above. In an aspect, the obtained photographic data or information that is provided by the single photograph of each fixed digital camera is sufficient to determine the positions of each of the fixed digital cameras with an accuracy that results in any Parallax error in the automotive crash test stereoscopic 3D motion analysis being less than about 2.5 mm.

In an aspect, the obtained photographic data or information that is provided by the single photograph of each fixed digital camera is sufficient to determine the positions of each of the fixed digital cameras with an accuracy that results in any Parallax error in the automotive crash test stereoscopic 3D motion analysis being less than about 1.0 mm.

### DRAWINGS

The present invention will become more fully understood from the detailed description and the accompanying drawings.

FIG. 1 is a left side perspective view including one example of a movable fixture positioned in relation to various other components as used in one example method in accordance with the present disclosure.

FIG. 2 is a right side perspective view of the example movable fixture positioned as in FIG. 1 for use in the example method.

FIG. 3 is a lower side plan view of the example movable fixture positioned as in FIG. 1 for use in the example method.

FIG. 4 is an upper side plan view of the example movable fixture positioned as in FIG. 1 for use in the example method.

FIG. 5 is a left side perspective view similar to FIG. 1 with the movable fixture positioned in relation to a different crash test barrier and different other components.

FIG. 6 is a left side perspective view of the example movable fixture of FIG. 1 and including an example field of view and visual target locus.

FIG. 7 is a right side perspective view of the example movable fixture of FIG. 1, and including a representative mechanical arm measuring device.

FIG. 8 is a lower side plan view of the example movable fixture of FIG. 1.

FIG. 9 is a upper side plan view of the example movable fixture of FIG. 1.

### DETAILED DESCRIPTION

Further areas of applicability will become apparent from the description, claims and drawings, wherein like reference numerals refer to like features throughout the several views of the drawings. It should be understood that the detailed description, including disclosed embodiments and drawings referenced therein are merely exemplary in nature, intended for purposes of illustration only, and are not intended to limit the scope of the present disclosure.

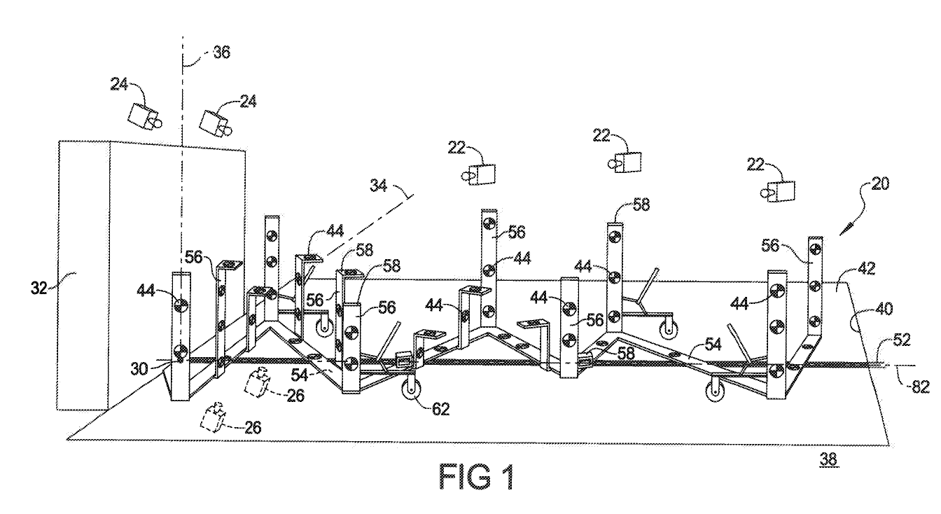

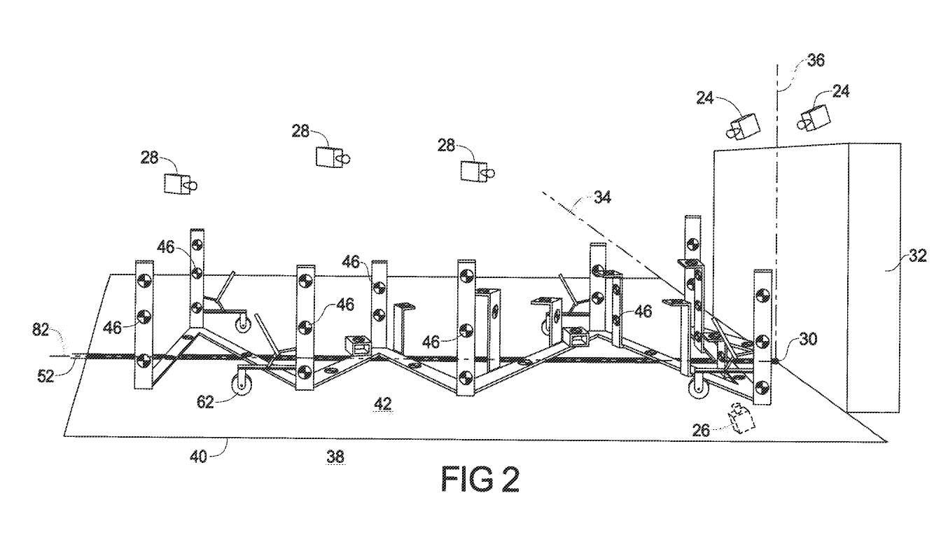

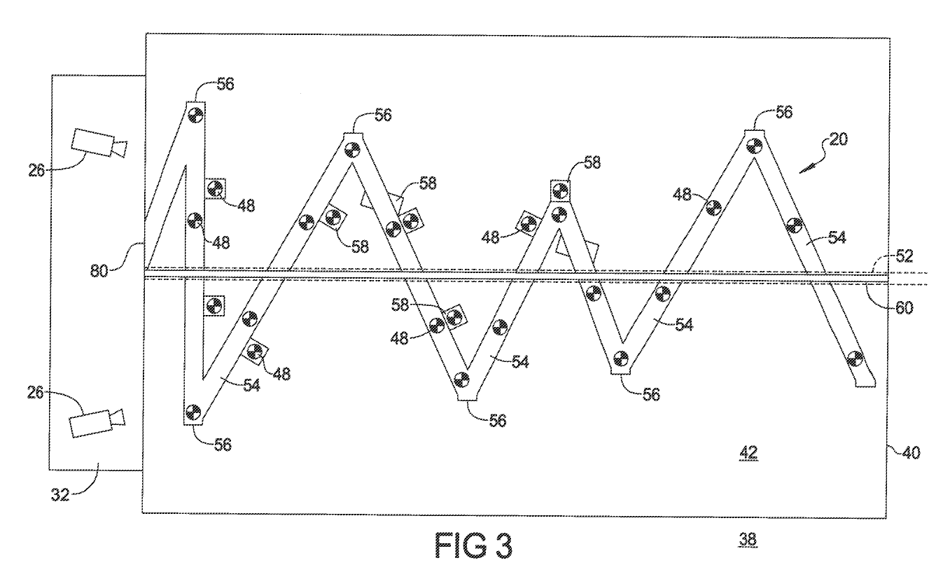

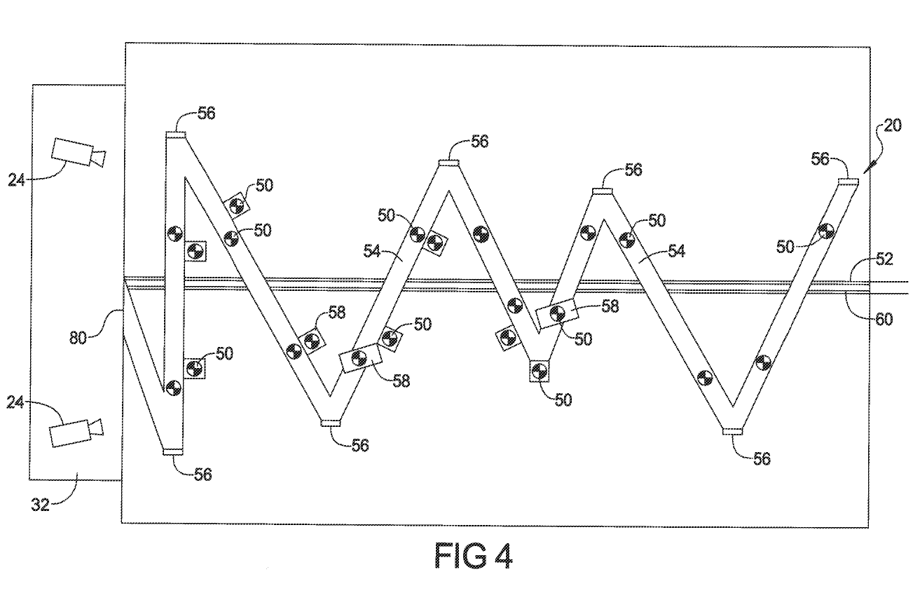

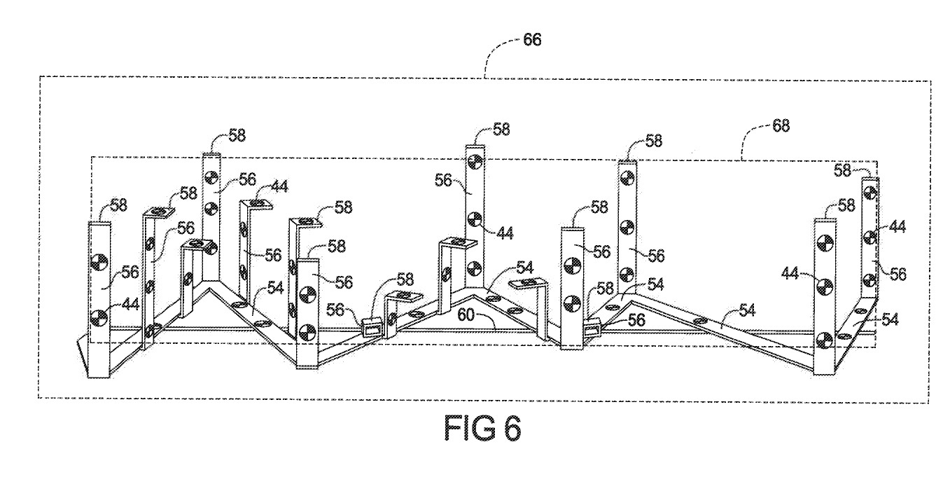

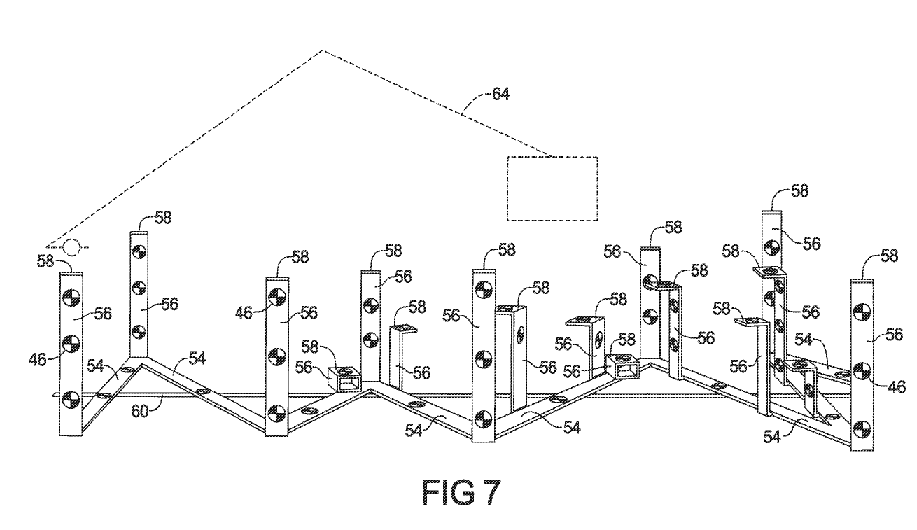

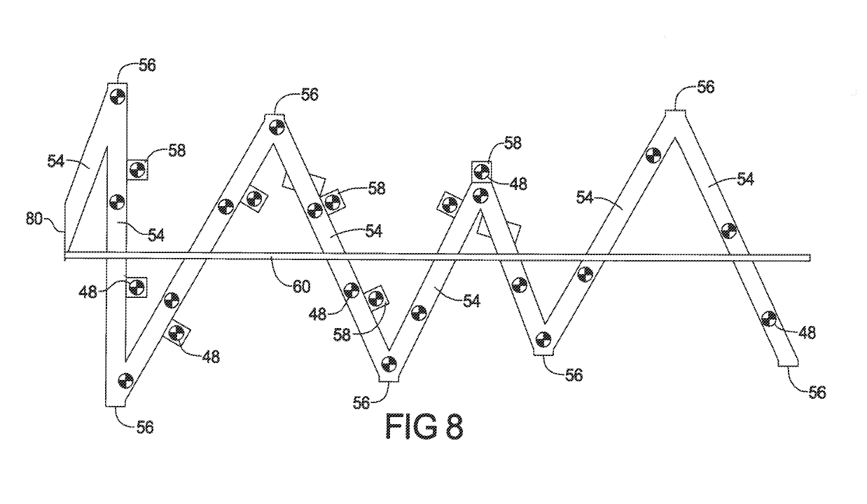

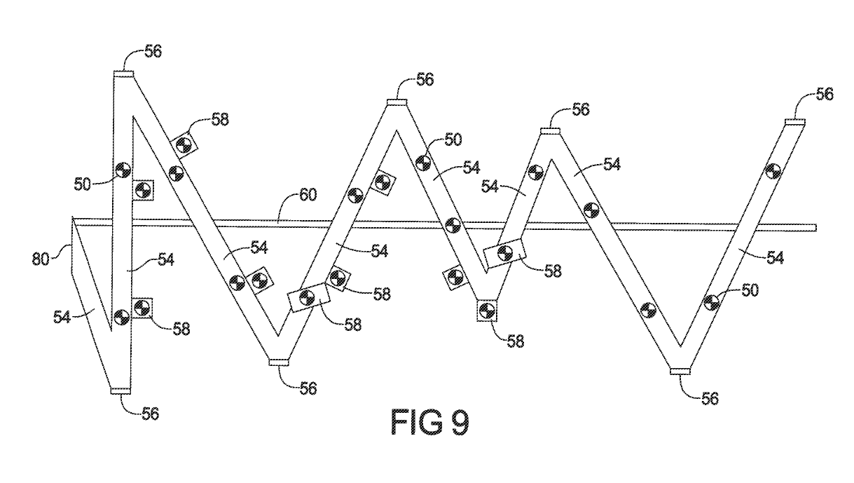

With reference to FIGS. 1-9, one example fixture 20 and method of obtaining photographic data sufficient to determine a position, including orientation, of each of a plurality of fixed digital cameras 22, 24, 26, 28 with respect to a point 30 in 3D space for automotive crash testing stereoscopic 3D motion analysis is described below. In order for such photographic data to be “sufficient” as noted above, it must provide enough information that the position of each camera 22, 24, 26, 28 can be determined with sufficient accuracy that any Parallax error is within the range required for automotive crash testing stereoscopic 3D motion analysis. As noted previously, in some instances automotive crash test stereoscopic 3D motion analysis requires that any Parallax error be no more than about 2.5 mm. In some instances, however, automotive crash test stereoscopic 3D motion analysis requires that any Parallax error be no more than about 1 mm.

One representative example automobile crash test facility includes a crash test barrier 32 and a plurality of digital cameras 22, 24, 26, 28. The digital cameras of this example include right side 22, left side 28, upper side 24, and lower side 26 digital cameras. The right and left side digital cameras 22, 28 are positioned on the right and left sides, respectively, of the fixture 20. In an aspect, right and left side digital cameras 22, 28 have a depth of field that generally extends along the Y-dimension or Y-axis direction 34. The upper and lower side digital cameras 24, 26 are positioned above and below the fixture, respectively. In an aspect, the upper and lower side digital cameras 24, 26 have a depth of field that generally extends along the Z-dimension or Z-axis direction 36. The lower side digital cameras 26 are positioned below the automobile driving surface 38 and look up through an opening 40 in the driving surface 38, which is covered by a transparent window 42 in some cases. In an aspect, at least some of the digital cameras 22, 24, 26, 28 have a depth of field that extends to some extent along the X-dimension or X-axis direction 82.

At least 20 left side visual targets 44 are supported on a movable fixture 20 at different points in a 3D space of the movable fixture 20, and with at least 5 of the 20 left side visual targets positioned at different Y-dimension 34 distances. In addition, at least 20 right side visual targets 46 are supported on the movable fixture 20 at different points in the 3D space of the movable fixture 20 and with at least 5 of the 20 left side visual targets positioned at different Y-dimension 34 distances. As used above, right and left “side visual targets” means visual targets visible to the left and right side fixed digital cameras on the left and right side of the fixture, respectively.

In one aspect, at least 20 lower side visual targets 48 are supported on the movable fixture 20 at different points in the 3D space of the movable fixture 20 and with at least 5 of the 20 lower side visual targets positioned at different Z-dimension 36 distances. In another aspect, at least 20 upper side visual targets 50 are supported on the movable fixture 20 at different points in the 3D space of the movable fixture 20, and with at least 5 of the 20 upper side visual targets 50 positioned at different Z-dimension distances. As used above, upper and lower “side visual targets” means visual targets that are visible to the upper and lower side fixed digital cameras above and below of the fixture, respectively.

In some cases, the same physical visual target is a left side visual target 44 and also an upper side visual target 50, or a lower side visual target 48, or both. In some cases, the same physical visual target is a right side visual target 46 and also an upper side visual target 50, or a lower side visual target 48, or both. In other cases, the same physical visual target on the fixture 20 functions as another combination of left side 44, right side 46, lower side 48, and upper side 50 visual targets.

In aspects of the illustrated example, a winch rail channel or opening 52 is provided in the driving surface 38 for use in pulling an automobile being tested toward the crash test barrier 32. The movable fixture 20 includes a zig-zag base 54 and a plurality of fixed arms 56 of different heights extending upward from the zig-zag base 54. The visual targets 22, 24, 26 28 are supported on the base 54 and on the arms 56, including flanges 58 extending from the arms 56 base 54. A fixed foot 60, such as the illustrated elongate bar, extends downward from the zig-zag base 54. The fixture 20 includes articulating wheels 62 to facilitate raising, lowering, and moving the movable fixture 20. When the wheels 62 are raised, the fixture is lowered, to help retain the movable fixture in a static position either against or adjacent to the barrier 32 as illustrated in FIGS. 1-4.

The locations of the visual targets 44, 46, 48, 50 are measured relative to each other on the movable fixture 20. Thus, the locations of the visual targets 44, 46, 48, 50 relative to each other are known, regardless of where the movable fixture 20 is positioned. In one aspect, the relative location measuring of the visual targets 44, 46, 48, 50 relative to each other is done using a mechanical arm-type coordinate measuring device 64. One example of such a mechanical arm-type measuring device 64 is a Faro Arm, available from Faro Technologies, Inc., of Lake Mary, Fla. The use of such a mechanical arm-type coordinate measuring device 64 was not possible or practical in previous methods where the visual targets 44, 46, 48, 50 were widely spaced around the crash test facility. Such mechanical arm-type coordinate measuring devices 64 simply do not have sufficient reach to practically measure the locations or positions of such widely spaced visual targets relative to each other. In contrast, the relative locations of the visual targets 44, 46, 48, 50 is performed much more quickly, easily, and is less costly.

The movable fixture 20, which rigidly supports the plurality of visual targets 44, 46, 48, 50 relative to each other, is positioned in a static position (FIGS. 1-4) adjacent an automotive crash test barrier 32. Due to its limited size, this spaces the plurality of targets 44, 46, 48, 50 throughout only a portion of the field of view of each of the fixed cameras 22, 24, 26, 28. Attempts to use the test automobile itself, with the visual targets 44, 46, 48, 50 mounted on it as a movable fixture were unsuccessful in providing photographic data sufficient to determine fixed digital camera positions with the accuracy required for automotive crash testing stereoscopic 3D motion analysis. This led to a belief that any fixture supporting the visual targets must be larger than a car. This also led to the belief that the visual targets must be spaced throughout a locus that fills the entire visual field of the fixed cameras 22, 24, 26, 28.

In contrast to the belief that any fixture supporting the visual targets must be larger than a car, in one aspect, the visual targets are supported within a 3D space of the movable fixture 20, which has X, Y and Z dimensions that are less than about the corresponding overall X, Y and Z dimensions of a car to be tested. In another aspect, the visual targets are supported within the 3D space, which has an overall X dimension (height) that is less than about 1.5 meters, an overall Y dimension (width) that is less than about 2 meters, and an overall Z (length) dimension that is less than about 5 meters. Such dimensions are roughly equivalent to those of the current average mid-sized car.

In contrast to the belief that the visual targets 44, 46, 48, 50 must be spaced or moved throughout a locus that fills essentially the entire visual field 66 of the fixed cameras 22, 24, 26, 28, in one aspect, the visual targets 44, 46, 48, 50 are supported within the 3D space or locus 68 of each field of view 66 that covers less than about 80 percent of the field of view 66 for each of the fixed cameras 22, 24, 26, 28. In another aspect, the visual targets 44, 46, 48, 50 are supported within the 3D space or locus 68 of the field of view 66 that covers from about 55 percent to about 75 percent of the field of view 66 for each of the fixed cameras 22, 24, 26, 28.

Each fixed digital camera 22, 24, 26, 28 takes a single photograph of the movable fixture 20 while it is in the static position (FIGS. 1-4) to obtain the photographic data. Thus, a single image or photograph from each of the fixed digital cameras 22, 24, 26, 28 is all that is required to obtain sufficient photographic data. This is in contrast to attempts to move a fixture throughout the 3D space while fixed cameras take a series of images or photographs as a way to obtain photographic data of a visual target that, over time, is spaced throughout the entirety of the field of view of the cameras.

After obtaining the photographic data from the movable fixture 20 in the static position, the fixture 20 is moved away from the automotive crash barrier 32 prior to performing an automotive crash test using the barrier 32.

In one aspect, positioning the movable fixture in the static position includes positioning the zig-zag base 54 adjacent the crash test barrier 32 with the plurality of arms 56 of different heights extending upward from the zig-zag base 54 of the movable fixture 20 and with the visual targets 44, 46, 48, 50 supported on the arms 56, the zig-zag base 54, or both. In another aspect, positioning the movable fixture 20 in the static position includes positioning the foot 60 of the movable fixture 20 in the winch rail channel or opening 52 adjacent the crash test barrier 32. In another aspect, positioning the movable fixture in the static position includes positioning an end 80 of the movable fixture 20 against the crash test barrier 32.

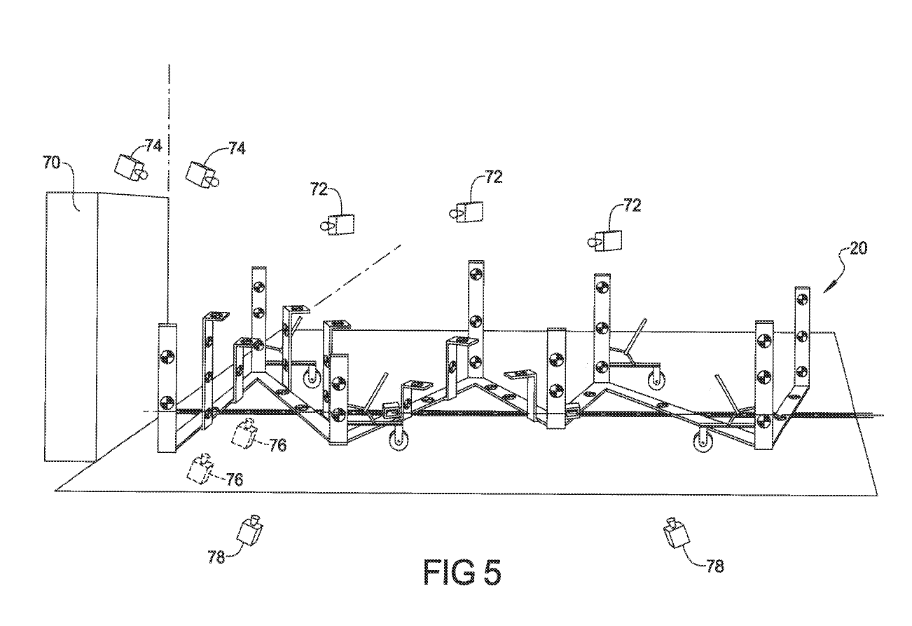

In other aspects illustrated in FIG. 5, the same movable fixture 20 is positioned in a different static position adjacent a different automotive crash barrier 70. Similar to the above, this spaces the plurality of targets 44, 46, 48, 50 throughout only a portion of the field of view of each of the fixed digital cameras or a different plurality of fixed digital cameras 72, 74, 76, 78. For example, where only the crash test barrier is replaced in the same location or facility, it is sometimes possible and desirable to use the same fixed cameras 22, 24, 26, 28. Where this is not so, such as when the different crash test barrier 70 is in a completely different location or facility, different fixed cameras 72, 74, 76, 78 are used.

Similar to before, in these aspects, each of the fixed digital cameras 22, 24, 26, 28 or different fixed digital cameras 72, 74, 76, 78 take a single photograph of the same movable fixture 20 in the different static position (FIG. 5) to obtain sufficient photographic data, and then the movable fixture 20 is moved away from the different automotive crash barrier 70 prior to performing an automotive crash test using the different barrier 70.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A high accuracy method of obtaining photographic data sufficient to determine a position, including orientation, of each of a plurality of fixed digital cameras with respect to a point in 3D space with an accuracy required for automotive crash testing stereoscopic 3D motion analysis, the method comprising:
supporting at least 20 left side visual targets on a movable fixture at different points in a 3D space of the movable fixture and with at least 5 of the 20 left side visual targets positioned at different Y-dimension distances;
supporting at least 20 right side visual targets on the movable fixture at different points in the 3D space of the movable fixture and with at least 5 of the 20 right side visual targets positioned at different Y-dimension distances;
measuring locations of the right side and left side visual targets relative to each other on the movable fixture;
positioning the movable fixture, which rigidly supports the plurality of visual targets relative to each other, in a static position adjacent an automotive crash test barrier and spacing the plurality of targets throughout only a portion of the field of view of each of the fixed digital cameras;
each fixed digital camera taking a single photograph of the movable fixture in the static position to obtain the photographic data;
moving the fixture away from the automotive crash barrier prior to performing an automotive crash test using the barrier.

2. The high accuracy method of claim 1, further comprising:
supporting at least 20 upper side visual targets on the movable fixture at different points in a 3D space of the movable fixture and with at least 5 of the 20 upper side visual targets positioned at different Z-dimension distances;
supporting at least 20 lower side visual targets on the movable fixture at different points in the 3D space of the movable fixture and with at least 5 of the 20 lower side visual targets positioned at different Z-dimension distances;
measuring locations of the upper side and lower side visual targets relative to each other and relative to the left and right side visual targets on the movable fixture.

3. The high accuracy method of claim 1, further comprising:
positioning the movable fixture in a different static position adjacent a different automotive crash barrier and spacing the plurality of targets throughout only a portion of the field of view of each of the fixed digital cameras or a different plurality of fixed digital cameras;
each fixed or different fixed digital camera taking a single photograph of the movable fixture in the different static position to obtain the photographic data;
moving the fixture away from the different automotive crash barrier prior to performing an automotive crash test using the different barrier.

4. The high accuracy method of claim 1, wherein the portion of the field of view is less than about 80 percent of the field of view of each of the fixed digital cameras.

5. The high accuracy method of claim 1, wherein supporting the plurality of visual targets comprises supporting the visual targets within the 3D space that has overall X, Y and Z dimensions that are less than about corresponding overall X, Y and Z dimensions of an automobile to be tested.

6. The high accuracy method of claim 1, wherein supporting the plurality of visual targets comprises supporting the visual targets within the 3D space that has an overall X dimension that is less than about 1.5 meters, an overall Y dimension that is less than about 2 meters, and an overall Z dimension that is less than about 5 meters.

7. The high accuracy method of claim 1, wherein the positioning the movable fixture comprises positioning a zig-zag base adjacent the crash test barrier with a plurality of arms of different heights extending upward from the zig-zag base of the movable fixture and with the visual targets supported on the arms, the zig-zag base, or both.

8. The high accuracy method of claim 1, wherein the positioning the movable fixture comprises positioning a foot of the movable fixture in a winch rail opening adjacent the crash test barrier.

9. The high accuracy method of claim 1, wherein the positioning the movable fixture comprises positioning a foot of the movable fixture below a zig-zag base in a winch rail opening adjacent the crash test barrier with a plurality of arms of different heights extending upwardly from the zigzag base of the movable fixture and with the visual targets supported on the arms, the zig-zag base, or both.

10. The high accuracy method of claim 1, wherein the measuring locations of the targets comprises using a mechanical arm-type coordinate measuring device in the measure locations of all the visual targets.

11. The high accuracy method of claim 1, wherein the obtained photographic data provided by the single photograph of each fixed digital camera is sufficient to determine the positions of each of the fixed digital cameras with an accuracy that results in any Parallax error in the automotive crash test stereoscopic 3D motion analysis being less than about 2.5 mm.

12. The high accuracy method of claim 1, wherein the obtained photographic data provided by the single photograph of each fixed digital camera is sufficient to determine the positions of each of the fixed digital cameras with an accuracy that results in any Parallax error in the automotive crash test stereoscopic 3D motion analysis being less than about 1.0 mm.
